(19) United States
(12) Patent Application Publication
(10) Pub. No.: US 2024/0365138 A1
(43) Pub. Date: Oct. 31, 2024

(54) METHOD, DEVICE AND SYSTEM FOR UPDATING SYSTEM INFORMATION

(71) Applicant: ZTE Corporation, Shenzhen (CN)

(72) Inventors: Yuan GAO, Shenzhen (CN); He HUANG, Shenzhen (CN)

(73) Assignee: ZTE Corporation, Shenzhen (CN)

(21) Appl. No.: 18/763,762

(22) Filed: Jul. 3, 2024

Related U.S. Application Data
(63) Continuation of application No. PCT/CN2022/070158, filed on Jan. 4, 2022.

(51) Int. Cl. H04W 24/02; H04W 56/00; H04W 64/00; H04W 84/06

(52) U.S. Cl. CPC H04W 24/02; H04W 56/0045; H04W 64/006; H04W 84/06

(57) ABSTRACT

A wireless communication method for use in a wireless terminal is disclosed. The method comprises receiving, from a wireless network node, an update indication associated with system information of a non-terrestrial network and acquiring the system information based on the update indication.

### CROSS REFERENCE TO RELATED APPLICATIONS

The present disclosure is a continuation of International Patent Application No. PCT/CN2022/070158, filed on Jan. 4, 2022, which is incorporated by reference in its entirety into the present application.

### TECHNICAL FIELD

This document is directed generally to wireless communications, and in particular to non-terrestrial network communications, especially a method for updating the system information, device thereof and system thereof.

### BACKGROUND

In a non-terrestrial network (NTN), due to its long propagation delay, a user equipment (UE) with a Global Navigation Satellite System (GNSS) capability needs to pre-compensate a timing advance (TA) based on uplink synchronization assistance information provided from the network (NW). The NW broadcasts a common TA, a TA drift rate and a TA drift variation allowing the UE to compensate the TA between a satellite and a network node on the Earth. In addition to the common TA, the UE may also compensate the TA between the UE and the satellite based on an ephemeris of the serving satellite, so that the full TA between the UE and the network node can be compensated.

To ensure an accuracy of the TA pre-compensation, the common TA, the TA drift rate and variations as well as the ephemeris and some other information used for a random access with a high accuracy should be provided. If the movement of the satellite is taken into consideration, the NW needs to update such information frequently to ensure the high accuracy. However, the existing system information update procedure may not be enough for such frequent update.

### SUMMARY

This document relates to a method for updating the system information, device thereof and systems thereof, and in particular to a method for updating the system information of an NTN, device thereof and systems thereof.

The present disclosure relates to a wireless communication method for use in a wireless terminal. The method comprises:
receiving, from a wireless network node, an update indication associated with system information of a non-terrestrial network, and
acquiring the system information based on the update indication.
Various embodiments may implement the following features.

In some embodiments, the system information comprises at least one of: a common timing advance, TA, a drift rate of the common TA, a variation of the drift rate of the common TA, a x-coordinate of a serving node position state vector in an Earth-centered Earth-fixed, ECEF, coordinate system, a y-coordinate of the serving node position state vector in the ECEF coordinate system, a z-coordinate of serving node position state vector in the ECEF coordinate system, a x-coordinate of serving node velocity state vector in the ECEF coordinate system, a y-coordinate of serving node velocity state vector in the ECEF coordinate system, a z-coordinate of serving node velocity state vector in the ECEF coordinate system, a semi-major axis of a serving node, an eccentricity of the serving node, an argument of periapsis of the serving node, a longitude of ascending node of the serving node, an inclination of the serving node, a mean anomaly at an epoch time of the serving node, a validity duration of the system information, an epoch time of the system information, polarization information for downlink transmissions on a service link, polarization information for an uplink service link, a reference location of a serving cell, time information indicating when a cell is going to stop serving the area covered by the cell or an indication of terminal specific TA reporting.

In some embodiments, acquiring the system information based on the update indication comprises acquiring the system information when a valid duration indicated by the update indication passes.

In some embodiments, the wireless communication method further comprises receiving, from the wireless network node, an indication bit set to indicate a modification of a broadcast channel, and acquiring the system information based on the update indication comprises acquiring the system information when a value tag comprised in the update indication is updated.

In some embodiments, a maximum value of the value tag is greater than 31.

In some embodiments, the value tag is configured for a system information block comprising the system information.

In some embodiments, acquiring the system information based on the update indication comprises: acquiring the system information when an indication bit comprised in the update indication indicates that the system information is updated.

In some embodiments, the indication bit is in a short message or paging downlink control information.

In some embodiments, the system information is acquired via a broadcast channel or a radio resource control message.

In some embodiments, the system information comprises at least one of uplink synchronization assistance information or system information dedicated for the non-terrestrial network.

The present disclosure relates to a wireless communication method for use in a wireless network node. The method comprises:
transmitting, to a wireless terminal, an update indication associated with system information of a non-terrestrial network, and
transmitting, to the wireless terminal, the system information.

Various embodiments may implement the following features.

In some embodiments, the system information comprises at least one of: a common timing advance, TA, a drift rate of the common TA, a variation of the drift rate of the common TA, a x-coordinate of a serving node position state vector in an Earth-centered Earth-fixed, ECEF, coordinate system, a y-coordinate of the serving node position state vector in the ECEF coordinate system, a z-coordinate of serving node position state vector in the ECEF coordinate system, a x-coordinate of serving node velocity state vector in the ECEF coordinate system, a y-coordinate of serving node velocity state vector in the ECEF coordinate system, a z-coordinate of serving node velocity state vector in the ECEF coordinate system, a semi-major axis of a serving node, an eccentricity of the serving node, an argument of periapsis of the serving node, a longitude of ascending node of the serving node, an inclination of the serving node, a mean anomaly at an epoch time of the serving node, a validity duration of the system information, an epoch time of the system information, polarization information for downlink transmissions on a service link, polarization information for an uplink service link, a reference location of a serving cell, time information indicating when a cell is going to stop serving the area covered by the cell or an indication of terminal specific TA reporting.

In some embodiments, the update indication comprises a valid duration of the system information.

In some embodiments, the update indication comprises a value tag which is updated, and the method further comprises transmitting, to the wireless terminal, an indication bit set to indicate a modification of a broadcast channel.

In some embodiments, a maximum value of the value tag is greater than 31.

In some embodiments, the value tag is configured for a system information block comprising the system information.

In some embodiments, the update indication comprises an indication bit set to indicate that the system information is updated.

In some embodiments, the indication bit is in a short message or paging downlink control information.

In some embodiments, the system information is transmitted via a broadcast channel or a radio resource control message.

In some embodiments, the system information comprises at least one of uplink synchronization assistance information or system information dedicated for the non-terrestrial network.

The present disclosure relates to a wireless terminal. The wireless terminal comprises:
a communication unit, configured to receive, from a wireless network node, an update indication associated with system information of a non-terrestrial network, and
a processor configured to acquire the system information based on the update indication.

Various embodiments may implement the following feature.

In some embodiments, the processor is further configured to perform any of the aforementioned wireless communication methods.

The present disclosure relates to a wireless network node. The wireless network node comprises:
a communication unit, configured to:
transmit, to a wireless terminal, an update indication associated with system information of a non-terrestrial network, and
transmit, to the wireless terminal, the system information.

Various embodiments may implement the following feature.

In some embodiments, the wireless network node further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF THE DRAWINGS

The above and other aspects and their implementations are described in greater detail in the drawings, the descriptions, and the claims.

FIG. 1 shows a schematic diagram of a network according to some embodiments of the present disclosure.

FIG. 2 shows a schematic diagram of a procedure according to some embodiments of the present disclosure.

FIG. 3 shows a schematic diagram of a procedure according to some embodiments of the present disclosure.

FIG. 4 shows a schematic diagram of a procedure according to some embodiments of the present disclosure.

FIG. 5 shows a schematic diagram of a procedure according to some embodiments of the present disclosure.

FIG. 6 shows a schematic diagram of a procedure according to some embodiments of the present disclosure.

FIG. 7 shows a schematic diagram of a procedure according to some embodiments of the present disclosure.

FIG. 8 shows a schematic diagram of a procedure according to some embodiments of the present disclosure.

FIG. 9 shows a schematic diagram of a procedure according to some embodiments of the present disclosure.

FIG. 10 shows a schematic diagram of a procedure according to some embodiments of the present disclosure.

FIG. 11 shows a schematic diagram of a procedure according to some embodiments of the present disclosure.

FIG. 12 shows an example of a schematic diagram of a wireless terminal according to some embodiments of the present disclosure.

FIG. 13 shows an example of a schematic diagram of a wireless network node according to some embodiments of the present disclosure.

FIG. 14 shows a flowchart of a method according to some embodiments of the present disclosure.

FIG. 15 shows a flowchart of a method according to some embodiments of the present disclosure.

### DETAILED DESCRIPTION

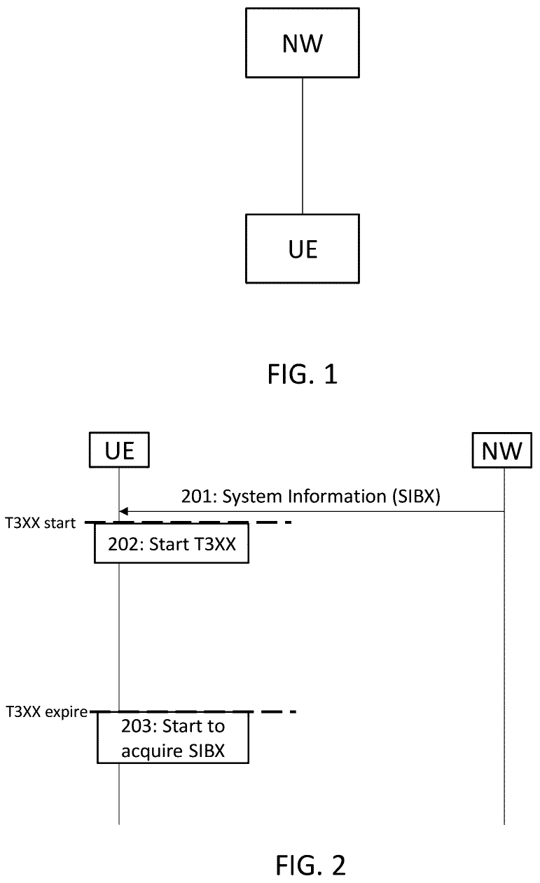

FIG. 1 shows a schematic diagram of a network (architecture) according to some embodiments of the present disclosure. In FIG. 1, the network (architecture) comprises a user equipment (UE) and a network (NW) (entity). The NW may comprise one or more network nodes and/or network entities such as Radio Access Network (RAN) node, Access and Mobility Management function (AMF), Session Management function (SMF), Policy Control function (PCF), User Plane Function (UPF), Application Function (AF), Unified Data Management (UDM), . . . , etc. The network in FIG. 1 may be an NTN. That is the UE may communicate with the NW via a satellite, a high-altitude platform station (HAPS), an HAPS as International Mobile Telecommunications base stations (HIBS), a plane or an unmanned aerial vehicle (UAV).

In some embodiments of the present disclosure, the UE receives an indication showing/indicating that uplink synchronization assistance information or the system information comprising synchronization assistance information is updated and (accordingly) acquires the updated uplink synchronization assistance information or the system information comprising the synchronization assistance information. For example, a process according to some embodiments of the present disclosure may comprise:

STEP 1: The UE receives, from the network, an indication showing that the uplink synchronization assistance information or the system information comprising the synchronization assistance information is updated.

STEP 2: The UE acquires the updated uplink synchronization assistance information or the system information comprising the synchronization assistance information (in response to the received indication).

In some embodiments, the uplink synchronization assistance information includes one or more of the following parameters:
Network controlled common TA, e.g. TACommon
Drift rate of the common TA, e.g. TACommonDrift
Variation of the common TA drift rate, e.g.TACommonDriftVariation
x-coordinate of serving Satellite position state vector in ECEF, e.g. ServingSatelliteEphemerisStateVectorX
y-coordinate of serving Satellite position state vector in ECEF, e.g. ServingSatelliteEphemerisStateVectorY
z-coordinate of serving Satellite position state vector in ECEF, e.g. ServingSatelliteEphemerisStateVectorZ
x-coordinate of serving Satellite velocity state vector in ECEF, e.g. ServingSatelliteEphemerisStateVectorVx, The unit is m/s.
y-coordinate of serving Satellite velocity state vector in ECEF, e.g. ServingSatelliteEphemerisStateVectorVy. The unit is m/s.
z-coordinate of serving Satellite velocity state vector in ECEF, e.g. ServingSatelliteEphemerisStateVectorVz. The unit is m/s.
Semi-major axis a of the serving satellite, e.g. ServingSatelliteEphemerisSemiMajorAxis
Eccentricity of the serving satellite, e.g. ServingSatelliteEphemerisEccentricityE
Argument of periapsis o of the serving satellite, e.g.
ServingSatelliteEphemerisArgumentOfPeriapsis
Longitude of ascending node Q of the serving satellite, e.g. ServingSatellite EphemerisLongitudeOfAscendingNode
Inclination i of the serving satellite, e.g. ServingSatelliteEphemerislnclinationI
Mean anomaly M [rad] at epoch time of the serving satellite, e.g. ServingSatelliteEphemerisMeanAnomalyM
A validity duration configured by the network for the uplink synchronization assistance information (i.e. Serving satellite ephemeris and Common TA parameters). The validity duration indicates the maximum time during which the UE can apply assistance information without having acquired new assistance information, e.g. ntnUlSyncValidityDuration
The epoch time for the uplink synchronization assistance information (i.e. Serving satellite ephemeris and Common TA parameters), e.g. EpochTime. When explicitly provided by system information block (SIB) or through dedicated signaling, the epoch time is a starting time of a DL sub-frame, indicated by a system frame number (SFN) and a sub-frame number signaled together with the uplink synchronization assistance information. The reference point for the epoch time of the serving satellite ephemeris and Common TA parameters is an uplink time synchronization reference point.
Polarization information for Downlink transmission on service link (e.g. ntnPolarizationDL): This Polarization information indicates one of Right hand, Left hand circular polarizations (RHCP, LHCP) and Linear polarization.
Polarization information for Uplink service link (e.g. ntnPolarizationUL). If ntnPolarizationUL is not present and the ntnPolarizationDL is present, the UE assumes the same polarization for both UL and DL transmissions.
Reference location of the serving cell, e.g. the location of the cell center.
The time information indicating when a cell is going to stop serving the area it is currently covering, e.g. t-Service.
An indication to UE specific timing advance reporting, e.g. enableTA-Report-r17.

In some embodiments, the indication showing that the uplink synchronization assistance information or the system information comprising the synchronization assistance information is updated may be configured in various forms.

For example, the indication showing that the uplink synchronization assistance information or the system information comprising the synchronization assistance information is updated may comprise a valid time duration for the information comprised in the uplink synchronization assistance information. The UE starts a timer (e.g. T3xx) when receiving the valid duration and considers such uplink synchronization assistance information will be updated when or after the timer expires. In this embodiment, the uplink synchronization assistance information may be included in an existing SIB or a newly introduced SIBX for the NTN. The uplink synchronization assistance information can be divided into multiple parts with different valid time durations. For example, the satellite ephemeris of the serving satellite may be expressed in two different formats:

Format 1: the state vectors, e.g. the ServingSatelliteEphemerisStateVectorX,
ServingSatelliteEphemerisStateVectorY, ServingSatelliteEphemerisStateVectorZ,
ServingSatelliteEphemerisStateVectorVx, ServingSatelliteEphemerisStateVectorVy and
ServingSatelliteEphemerisStateVectorVz.

Format 2: the Orbital elements, e.g. the ServingSatelliteEphemerisSemiMajorAxis,
ServingSatelliteEphemerisEccentricityE, ServingSatelliteEphemerisArgumentOfPeriapsis,
ServingSatellite EphemerisLongitudeOfAscendingNode, ServingSatelliteEphemerislnclinationI and
ServingSatelliteEphemerisMeanAnomalyM.

The network may broadcast (uplink synchronization assistance information with/comprising) the satellite ephemeris in both the formats 1 and 2 and configures valid time durations separately for each of the satellite ephemeris in the formats 1 and 2. For example, the network may configure a valid duration t1 for (uplink synchronization assistance information with/comprising) the satellite ephemeris in format 1 and another valid duration t2 for (uplink synchronization assistance information with/comprising) the satellite ephemeris in format 2. As a result, the UE may start and maintain separate timers for the satellite ephemeris in each format upon reception. Note that, the valid durations t1 and t2 may be the same or different. Similarly, other parameters in the uplink synchronization assistance information corresponding to the satellite ephemeris in format 1 may be the same or different from those corresponding to the satellite ephemeris in format 2.

As an alternative or in addition, all parameters in the uplink synchronization assistance information are included in the existing SIB or a newly introduced SIB, which may be called SIB comprising the uplink synchronization assistance information hereinafter. In this embodiment, the UE considers the uplink synchronization assistance information in the existing SIB or the newly introduced SIB is updated when one of the following indications is provided:

Indication form 1: A value tag within a range from 0 to 511 is introduced for the SIB comprising the uplink synchronization assistance information. In this embodiment, when the SIB comprising the uplink synchronization assistance information is updated, the NW sets systemInfoModification in a Short Message to 1 and update the value tag for this SIB to inform UE. Upon reception of the systemInfoModification set to 1, the UE checks the value tag provided for the SIB comprising the uplink synchronization assistance information and considers/determines that the uplink synchronization assistance information in the SIB is updated when the value tag is updated (e.g. changes/varies).

For example, the SIB comprising the value tag showing whether the uplink synchronization assistance information is updated may be realized by:

| | |
|---|---|
| SchedulingInfo ::= | SEQUENCE { |
| si-BroadcastStatus | ENUMERATED {broadcasting, notBroadcasting}, |
| si-Periodicity | ENUMERATED {rf8, rf16, rf32, rf64, rf128, rf256, rf512}, |
| sib-MappingInfo | SIB-Mapping |

}

| | |
|---|---|
| SIB-Mapping ::= | SEQUENCE (SIZE (1..maxSIB)) OF SIB-TypeInfo |
| SIB-TypeInfo ::= | SEQUENCE { |
| type | ENUMERATED {sibType2, sibType3, sibType4, sibType5, sibType6, |

sibType7, sibType8, sibType9,

sibType10-v1610, sibType11-v1610, sibType12-v1610,

sibType13-v1610, sibType14-v1610,

| | spare3, spare2, spare1,... }, | |
|---|---|---|
| valueTag | INTEGER (0..31) | OPTIONAL, -- Cond SIB-TYPE |
| ValueTag-r17 | INTEGER (0..511) | OPTIONAL, -- Cond |

SIB-TYPE1

| | | |
|---|---|---|
| areaScope | ENUMERATED {true} | OPTIONAL -- Need |

S
}
-- TAG-SI-SCHEDULINGINFO-STOP
-- ASN1STOP

Note that, the ValueTag-R17, whose value is within 0 and 511, is configured for the SIB comprising the uplink synchronization assistance information and configured to indicate whether the uplink synchronization assistance information in the SIB is updated. The ValueTag-R17 with range 0-511 can be introduced in the existing SIB1 or a new SIB1 comprising scheduling information of NTN/HAPS specific SIBs.

In some embodiments, the presence condition for the newly introduced value tag can be found in Table 1:

TABLE 1
Conditional Present Fields Implementation Example

| Condi- | |
|---|---|
| tional | |
| presence | Explanation |
| MSG-1 | The field is optionally present, Need R, if si-BroadcastStatus |
| | is set to notBroadcasting for any SI-message included in |
| | SchedulingInfo. It is absent otherwise. |
| SIB-TYPE | The field is mandatory present if the SIB type is different |
| | from SIB6, SIB7 or SIB8. For SIB6, SIB7 and SIB8 it is |
| | absent. |
| SIB- | Example 1: The field is mandatory present for the SIB |
| TYPE1 | comprising NTN/HAPS system information, e.g. SIBX. |
| | Example 2: The field is mandatory present for the SIB |
| | compromising the uplink synchronization assistance |
| | information. |
| SUL- | The field is optionally present, Need R, if |
| MSG-1 | supplementaryUplink is configured in |
| | ServingCellConfigCommonSIB and if si-BroadcastStatus is |
| | set to notBroadcasting for any SI-message included in |
| | SchedulingInfo. It is absent otherwise. |

In this embodiment, the SIB comprising the uplink synchronization assistance information comprises the field “SIB-TYPE1”, e.g., to be differentiated from other SIB.

In some embodiments, the Short Message associated with the indication of checking the value tag indicating whether the uplink synchronization assistance information is updated may be implemented as Table 2:

TABLE 2
Short Message Implementation Example

| Bit | Short Message |
|---|---|
| 1 | systemInfoModification |
| | If set to 1: indication of a BCCH modification other than SIB6, |
| | SIB7 and SIB8. |
| 2 | etwsAndCmasIndication |
| | If set to 1: indication of an ETWS primary notification and/or an |
| | ETWS secondary notification and/or a CMAS notification. |
| 3 | stopPagingMonitoring |
| | This bit can be used for only operation with shared spectrum |
| | channel access and if |
| | nrofPDCCH-MonitoringOccasionPerSSB-InPO is present. |
| | If set to 1: indication that the UE may stop monitoring PDCCH |
| | occasion(s) for paging in this Paging Occasion as specified in TS |
| | 38.304 [20], clause 7.1. |
| 4-8 | Not used in this release of the specification, and shall be ignored by |
| | UE if received. |

In the embodiment of the indication form 1, the Short Message transmitted to the UE comprises the systemInfoModification (i.e. 1^{st} Bit in the Short Message) which is set to 1, to indicate/instruct the UE to check the value tag introduced for the SIB comprising the uplink synchronization assistance information.

Indication form 2: In some embodiments, a new indication bit, e.g. uplinkSyncAssistanceInfoIndication or ntnsystemInfoModification, is introduced in the Short Message or paging downlink control information (DCI) for the SIB comprising the uplink synchronization assistance information. The SIB comprising the uplink synchronization assistance information may also comprise other information associated with NTN or HAPS (i.e. NTN/HAPS system information). The UE may determine that the uplink synchronization assistance information in this SIB is updated when the newly introduced indication bit is set to 1.

In some embodiments, the Short Message may be implemented as Table 3:

TABLE 3
Short Message Implementation Example

| Bit | Short Message |
|---|---|
| 1 | systemInfoModification |
| | If set to 1: indication of a BCCH modification other than SIB6, |
| | SIB7 and SIB8. |
| 2 | etwsAndCmasIndication |
| | If set to 1: indication of an ETWS primary notification and/or an |
| | ETWS secondary notification and/or a CMAS notification. |
| 3 | stopPagingMonitoring |
| | This bit can be used for only operation with shared spectrum |
| | channel access and if |
| | nrofPDCCH-MonitoringOccasionPerSSB-InPO is present. |
| | If set to 1: indication that the UE may stop monitoring PDCCH |
| | occasion(s) for paging in this Paging Occasion as specified in TS |
| | 38.304 [20], clause 7.1. |
| 4 | uplinkSyncAssistanceInfoIndication |
| | If set to 1: indication of an uplink synchronization assistance |
| | information modification. |
| 5-8 | Not used in this release of the specification, and shall be ignored by |
| | UE if received. |

In this embodiment, the 4^{th} bit uplinkSyncAssistanceInfoIndication in the Short Message is used to indicate whether the uplink synchronization assistance information is updated/modified. For example, the 4^{th} bit uplinkSyncAssistanceInfoIndication in the Short Message is set to 1 for indicating a modification/update of the uplink synchronization assistance information.

In some embodiments, the Short Message may be implemented as Table 4:

TABLE 4
Short Message Implementation Example

| Bit | Short Message |
|---|---|
| 1 | systemInfoModification |
| | If set to 1: indication of a BCCH modification other than SIB6, |
| | SIB7 and SIB8. |
| 2 | etwsAndCmasIndication |
| | If set to 1: indication of an ETWS primary notification and/or an |
| | ETWS secondary notification and/or a CMAS notification. |
| 3 | stopPagingMonitoring |
| | This bit can be used for only operation with shared spectrum |
| | channel access and if |
| | nrofPDCCH-MonitoringOccasionPerSSB-InPO is present. |
| | If set to 1: indication that the UE may stop monitoring PDCCH |
| | occasion(s) for paging in this Paging Occasion as specified in TS |
| | 38.304 [20], clause 7.1. |
| 4 | ntnsystemInfoModification |
| | If set to 1: indication of an NTN/HAPS specific SIB, i.e. SIBX, |
| | modification. |
| 5-8 | Not used in this release of the specification, and shall be ignored by |
| | UE if received. |

In this embodiment, the 4^{th} bit ntnsystemInfoModification in the Short Message is used to indicate whether the system information associated with the NTN or HAPS (e.g. the uplink synchronization assistance information and/or other NTN specific parameters) is updated/modified. For example, the 4^{th} bit ntnsystemInfoModification in the Short Message is set to 1 for indicating a modification/update of the system information associated with the NTN or HAPS.

In some embodiments, the UE may acquire the updated uplink synchronization assistance information in at least one of the following cases:

Case 1: In some embodiments, the valid time duration for the uplink synchronization assistance information is configured. The UE starts a timer, e.g. T3xx, when the valid duration is received and starts to acquire the updated uplink synchronization assistance information when or after the timer expires. The UE may re-acquire the SIB1 to check the scheduling information of the SIB comprising the uplink synchronization assistance information and acquire the updated SIB based on the scheduling information.

Case 2: In some embodiments, a value tag within range [0, 511] is introduced for the SIB comprising the uplink synchronization assistance information. The SIB can be an existing SIB or a newly introduced SIBX. The UE starts to acquire the updated SIB comprising the uplink synchronization assistance information when receiving the Short Message comprising systeminfoModification set to 1 and the value tag for this SIB is updated. When or after receiving Short Message comprising systemInfoModification set to 1, the UE reacquires the MIB and/or SIB1 from a start of next modification period and checks the value tag in the scheduling information for the SIB comprising the uplink synchronization assistance information. If the value tag is updated, the UE acquires the updated SIB, e.g., based on the corresponding scheduling information.

Case 3: In some embodiments, a new indication bit, e.g. uplinkSyncAssistanceInfoIndication or ntnsystemInfoModification, is introduced in Short Message or paging DCI for the SIB comprising the uplink synchronization assistance information and/or the NTN specific system information. The UE acquires the updated SIB and/or or the NTN specific system information according to the scheduling information in the valid SIB1 or the latest SIB1.

The following operations may be performed by the UE when the UE starts to acquire the updated SIB and/or the NTN specific system information.
In some embodiments, the UE is NTN capable, the indication bit (e.g. uplinkSyncAssistanceInfoIndication or ntnsystemInfoModification) of the Short Message is set to 1 and the UE is provided with searchSpaceSIB1 and searchSpaceOtherSystemInformation on an active BWP or the initial BWP. In this embodiment, the UE (immediately) re-acquires the SIB1. If si-SchedulingInfo in the SIB1 includes scheduling information for the SIB comprising the uplink synchronization assistance information and/or the NTN specific system information, the UE acquires the SIB as specified (immediately).
In some embodiments, the UE acquires the master information block (MIB), SIB1 and the updated SIB from the start of next modification period.
   In some embodiments, the UE may acquire the updated uplink synchronization assistance information in at least one of the following ways:
For the UE in idle and inactive mode, if the broadcast status of the SIB comprising the updated uplink synchronization assistance information is set to broadcasting, the UE will receive the updated SIB via a broadcast channel (BCCH) according the scheduling information in SIB1.
For the UE in idle and inactive mode, if the broadcast status of the SIB1 comprising the updated uplink synchronization assistance information is set to notBroadcasting, the UE requests the SIB via Msg1 or RRCSystemInfoRequest and the NW starts to broadcast the requested SIB so that the UE can acquire the requested SIB.
For the UE in connected mode, if the broadcast status of the SIB comprising the updated uplink synchronization assistance information is set to broadcasting and the UE has an active BWP configured with common search space with the field searchSpaceOtherSystemInformation, the UE acquires the updated SIB comprising the updated uplink synchronization assistance information via the BCCH according to the scheduling information in SIB1.
For the UE in connected mode, if the broadcast status of the SIB comprising the updated uplink synchronization assistance information is set to notbroadcasting and the UE has an active BWP configured with common search space with the field searchSpaceOtherSystemInformation, the UE requests the SIB via DedicatedSIBRequest and NW can either start to provide the updated SIB via the BCCH according to the scheduling information in SIB1 or via dedicatedSystemInformationDelivery in RRCReconfiguration message.
For the UE in connected mode, if the UE has an active BWP not configured with common search space with the field searchSpaceOtherSystemInformation, the UE requests the SIB via DedicatedSIBRequest and the NW may either configure the common search space with the field searchSpaceOtherSystemInformatio for an active BWP and start to provide the updated SIB via BCCH according to the scheduling information in SIB1 or provide the requested SIB via dedicatedSystemInformationDelivery in RRCReconfiguration message.

FIG. 2 shows a schematic diagram of a procedure according to some embodiments of the present disclosure. In FIG. 2, the modification/update of the uplink synchronization assistance information is indicated by a valid duration of the uplink synchronization assistance information. Specifically, the procedure shown in FIG. 2 comprises:

Step 201: The UE acquires system information broadcasted from the NW. The system information includes a SIBX which comprises the uplink synchronization assistance information and/or other NTN specific parameters. The SIBX may be an NTN specific SIB or an existing SIB. In this embodiment, a valid duration, e.g. ntnUlSyncValidityDuration, is also provided as the valid duration of the uplink synchronization assistance information or all the information in the SIBX.

Step 202: The UE starts a timer T3XX with the value set to the configured valid duration, e.g. ntnUlSyncValidityDuration.

Step 203: The UE starts to acquire the SIBX when the T3XX expires. For example, the UE may acquire the MIB and/or SIB1 to get the scheduling information of the SIBX and acquire SIBX based on the scheduling information.

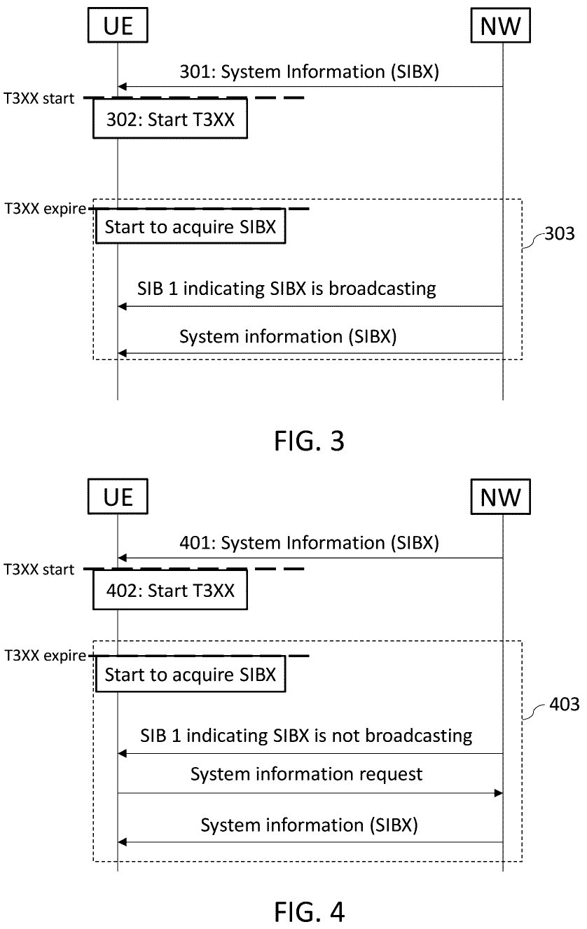

FIG. 3 shows a schematic diagram of a procedure according to some embodiments of the present disclosure. In this embodiment, the modification/update of the uplink synchronization assistance information is indicated by a valid duration of the uplink synchronization assistance information. Specifically, steps 301 and 302 are similar to steps 201 and 202 and are not illustrated herein for brevity.

Step 303: the UE is provided with searchSpaceSIB1 and searchSpaceOtherSystemInformation on an active BWP or an initial BWP. Upon expiration of the timer T3XX, the UE immediately re-acquires the SIB1 and the updated SIBX via system information (message) if the broadcast status of SIBX is set to broadcasting.

FIG. 4 shows a schematic diagram of a procedure according to some embodiments of the present disclosure. In this embodiment, the modification/update of the uplink synchronization assistance information is indicated by a valid duration of the uplink synchronization assistance information. Specifically, steps 401 and 402 are similar to steps 201 and 202 and are not illustrated herein for brevity.

Step 403: The UE is provided with searchSpaceSIB1 and searchSpaceOtherSystemInformation on an active BWP or an initial BWP. Upon expiration of the timer T3XX, the UE starts to acquire SIB1 to check the scheduling information of SIBX. If the broadcast status of SIBX is set to notbroadcasting, the UE initiates a system information request via Msg1 or RRCSystemInfoRequest or DedicatedSIBRequest message and starts to acquire the system information (message) comprising the SIBX.

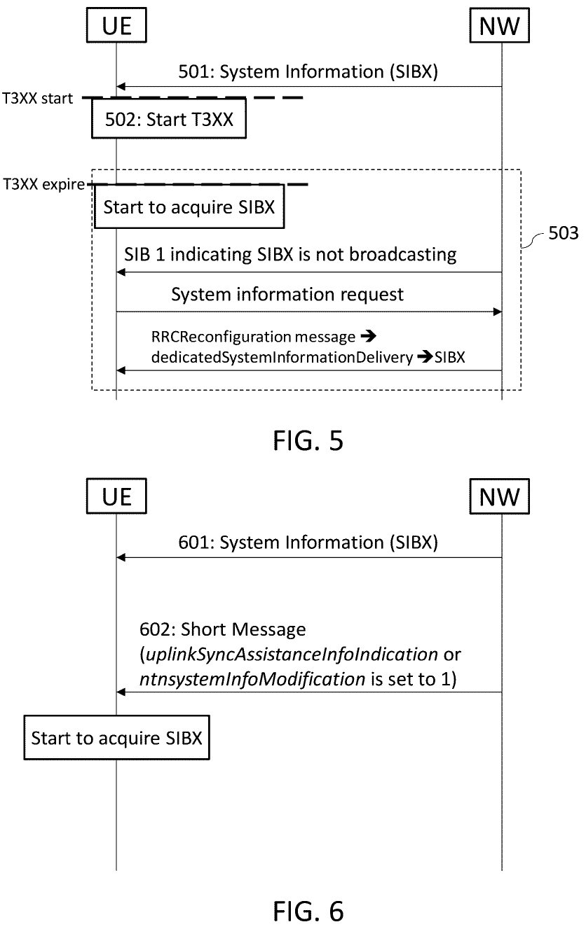

FIG. 5 shows a schematic diagram of a procedure according to some embodiments of the present disclosure. In this embodiment, the modification/update of the uplink synchronization assistance information is indicated by a valid duration of the uplink synchronization assistance information. Specifically, steps 501 and 502 are similar to steps 201 and 202 and are not illustrated herein for brevity.

In the embodiment shown in FIG. 5, the UE may be provided with searchSpaceSIB1 and not provided with searchSpaceOtherSystemInformation on the active BWP. Under such conditions, upon the expiration of the timer T3XX, the UE starts to acquire the broadcast the SIB1 to check the scheduling information of the SIBX. If the broadcast status of SIBX is set to notbroadcasting, the UE initiates a system information request via the Msg1 or the RRCSystemInfoRequest or the DedicatedSIBRequest message and acquires the updated SIBX provided via sequential/contiguous transmissions of RRCReconfiguration message→dedicatedSystemInformationDelivery→SIBX.

In the embodiment shown in FIG. 5, the UE may not be provided with searchSpaceSIB1 or searchSpaceOtherSystemInformation on the active BWP. In this embodiment, upon an expiration of the timer T3XX, the UE starts to acquire the SIB1 in sequential/contiguous transmissions of RRCReconfiguration message→dedicated SIB1-Delivery to check the scheduling information of SIBX. If the broadcast status of SIBX is set to notbroadcasting, the UE initiates a system information request via Msg1 or the RRCSystemInfoRequest or the DedicatedSIBRequest message and acquires the updated SIBX provided via sequential/contiguous transmissions of RRCReconfiguration message→dedicatedSystemInformationDelivery→SIBX.

FIG. 6 shows a schematic diagram of a procedure according to some embodiments of the present disclosure. In this embodiment, the Short Message may be implemented as Table 3 or Table 4. In FIG. 6, the UE acquires system information broadcasted from the NW, wherein the system information includes a SIBX comprising the uplink synchronization assistance information and/or some other NTN specific parameters. The SIBX may be an NTN specific SIB comprising the uplink synchronization assistance information and/or some other NTN specific parameters or the existing SIB comprising the uplink synchronization assistance information and/or some other NTN specific parameters (Step 601).

In step 602, the UE receives Short Message (e.g. via a paging procedure), wherein the bit uplinkSyncAssistanceInfoIndication or ntnsystemInfoModification (e.g. indication bit) in the received Short Message is set to “1”. Based on the bit uplinkSyncAssistanceInfoIndication or ntnsystemInfoModification, the UE starts to acquire the updated SIBX immediately. For example, the UE may acquire the SIB1 to get the scheduling information of SIBX and acquire the SIBX based on the acquired scheduling information.

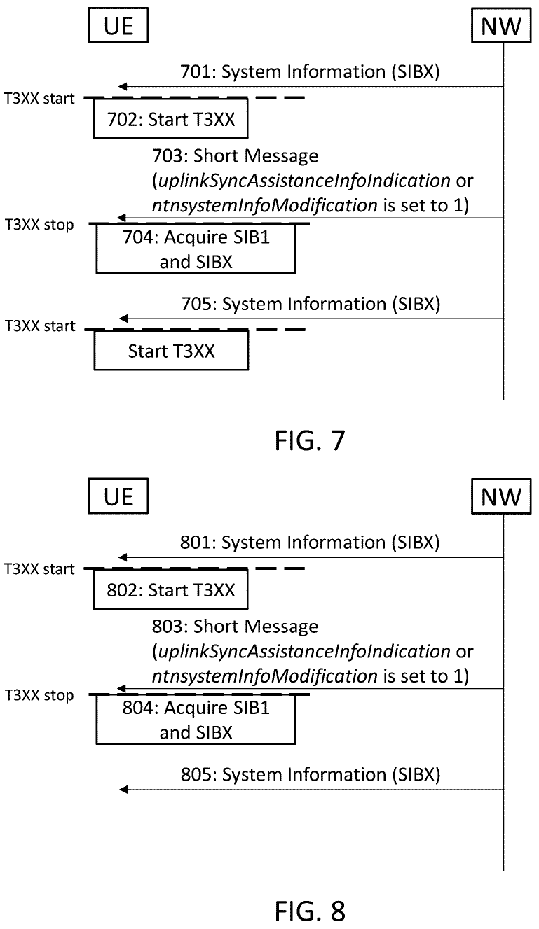

FIG. 7 shows a schematic diagram of a procedure according to some embodiments of the present disclosure. In FIG. 7, the modification/update of the uplink synchronization assistance information and/or other NTN specific parameters may be indicated by a valid duration of the uplink synchronization assistance information and an indication bit (in the Short Message). For example, the Short Message may be implemented as Table 3 or Table 4 and the indication bit may be the bit uplinkSyncAssistanceInfoIndication or ntnsystemInfoModification. Specifically, the procedure shown in FIG. 7 comprises:

Step 701: The UE acquires system information broadcasted from the NW, wherein the system information includes a SIBX which comprises the uplink synchronization assistance information and/or other NTN specific parameters. The SIBX may be an NTN specific SIB comprising the uplink synchronization assistance information and/or other NTN specific parameters or an existing SIB comprising the uplink synchronization assistance information and/or other NTN specific parameters. In this embodiment, a valid time, e.g. ntnUlSyncValidityDuration, is also provided as the valid duration of the uplink synchronization assistance information or all the information comprised in the SIBX.

Step 702: The UE starts a timer T3XX with a value set to the configured valid duration, e.g. ntnUlSyncValidityDuration.

Step 703: Before the timer T3XX expires, the UE receives a Short Message via paging, wherein the uplinkSyncAssistanceInfoIndication or ntnsystemInfoModification in the Short Message is set to “1”.

Step 704: In response to the received Short Message, the UE stops the timer T3XX and starts to acquire the SIBX immediately. For example, the UE may acquire the SIB1 to get the scheduling information of SIBX and acquire the SIBX accordingly.

Step 705: If a new valid duration is provided in the updated SIBX, the UE starts a timer T3XX with value set to this new time duration.

FIG. 8 shows a schematic diagram of a procedure according to some embodiments of the present disclosure. In FIG. 8, the modification/update of the uplink synchronization assistance information and/or other NTN specific parameters may be indicated by a valid duration of the uplink synchronization assistance information and an indication bit (in the Short Message). For example, the Short Message may be implemented as Table 3 or Table 4 and the indication bit may be the bit uplinkSyncAssistanceInfoIndication or ntnsystemInfoModification. Specifically, the procedure shown in FIG. 8 comprises:

Step 801: The UE acquires system information broadcasted from the NW. The system information includes a SIBX comprising the uplink synchronization assistance information and/or other NTN specific parameters. The SIBX may be an NTN specific SIB comprising the uplink synchronization assistance information and/or other NTN specific parameters. In this embodiment, a valid duration, e.g. ntnUlSyncValidityDuration is also provided as the valid duration of the uplink synchronization assistance information or all the information in the SIBX.

Step 802: The UE starts a timer T3XX with the value set to the configured valid duration, e.g. ntnUlSyncValidityDuration.

Step 803: Before the timer T3XX expires, the UE receives a Short Message via paging, wherein the bit uplinkSyncAssistanceInfoIndication or ntnsystemInfoModification in the Short Message is set to “1”.

Step 804: The UE stops the timer T3XX and starts to acquire the SIBX immediately. For instance, the UE may acquire the SIB1 to get the scheduling information of the SIBX and accordingly acquire the SIBX. In this embodiment, no valid duration is provided in the updated SIBX and the UE does not start the timer T3XX again.

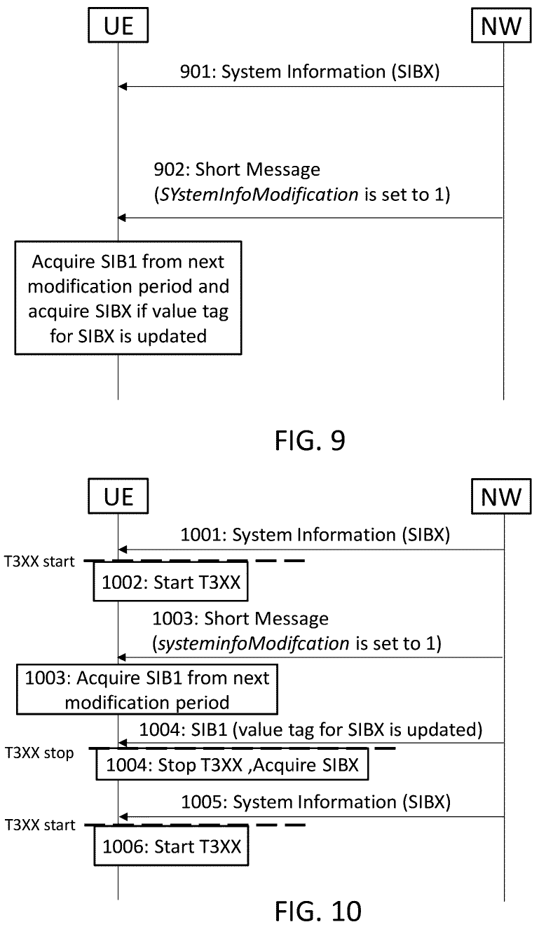

FIG. 9 shows a schematic diagram of a procedure according to some embodiments of the present disclosure. In FIG. 9, the modification/update of the uplink synchronization assistance information and/or other NTN specific parameters may be indicated by a value tag. Specifically, the procedure shown in FIG. 9 comprises: Step 901: The UE acquires system information broadcasted from the NW, wherein the system information includes a SIBX comprising the uplink synchronization assistance information and/or other NTN specific parameters. The SIBX may be an NTN specific SIB comprising the uplink synchronization assistance information and/or other NTN specific parameters or an existing SIB comprising the uplink synchronization assistance information and/or other NTN specific parameters. In this embodiment, a value tag is provided in the SIB1 for identifying whether the SIBX has been updated or not.

Step 902: The UE receives a Short Message via paging. The systemInfoModification in the Short Message is set to “1”, indicating that the system information has been updated. The UE starts to acquire the SIB1 to check the value tag associated with the SIBX. If the value tag is updated, the UE starts to acquire the SIBX from the next modification period.

FIG. 10 shows a schematic diagram of a procedure according to some embodiments of the present disclosure. In FIG. 10, the modification/update of the uplink synchronization assistance information and/or other NTN specific parameters may be indicated by a valid duration and a value tag. Specifically, the procedure shown in FIG. 10 comprises: Step 1001: The UE acquires system information broadcasted from the NW. The system information includes a SIBX comprising uplink synchronization assistance information and/or other NTN specific parameters. The SIBX may be an NTN specific SIB or an existing SIB. In this embodiment, a valid duration, e.g. ntnUlSyncValidityDuration, is provided as the valid duration of the uplink synchronization assistance information or all the information in the SIBX.

Step 1002: The UE starts a timer T3XX with a value set to the configured valid duration, e.g. ntnUlSyncValidityDuration.

Step 1003: Before the timer T3XX expires, the UE receives a Short Message via paging, wherein the systemInfoModification in the Short Message is set to “1”.

Step 1004: The UE acquires the SIB1 from the next modification period and checks the value tag associated with the SIBX.

Step 1005: If the value tag associated with the SIBX shows that SIBX has been updated (e.g. the value tag changes/is updated), the UE stops the timer T3XX and starts to acquire the SIBX according to the scheduling information in the SIB1.

Step 1006: If a new valid duration is provided in the updated SIBX, the UE starts the timer T3XX with the value set to this new time duration.

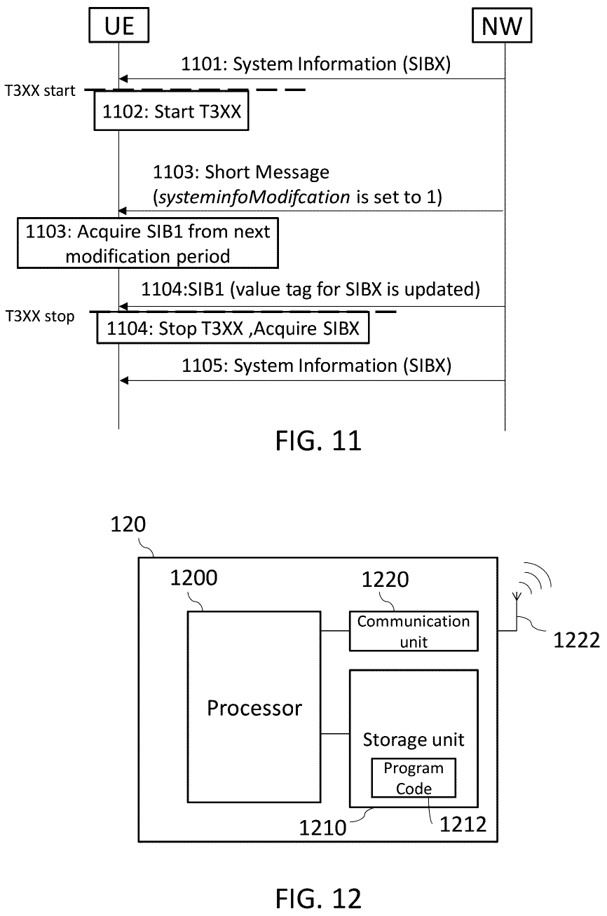

FIG. 11 shows a schematic diagram of a procedure according to some embodiments of the present disclosure. In FIG. 11, the modification/update of the uplink synchronization assistance information and/or other NTN specific parameters may be indicated by a valid duration and a value tag. Specifically, the procedure shown in FIG. 11 comprises: Step 1101: The UE acquires system information broadcasted from the NW. The system information includes a SIBX comprising uplink synchronization assistance information and/or other NTN specific parameters. The SIBX may be an NTN specific SIB or an existing SIB. In this embodiment, a valid duration, e.g. ntnUlSyncValidityDuration, is provided as the valid duration of the uplink synchronization assistance information or all the information in the SIBX.

Step 1102: The UE starts a timer T3XX with a value set to the configured valid duration, e.g. ntnUlSyncValidityDuration.

Step 1103: Before the timer T3XX expires, the UE receives a Short Message via paging, wherein the systemInfoModification in the Short Message is set to “1”.

Step 1104: The UE acquires the SIB1 from the next modification period and checks the value tag associated with the SIBX.

Step 1105: The value tag associated with the SIBX shows that SIBX has been updated (e.g. the value tag changes/is updated), the UE stops the timer T3XX and starts to acquire the SIBX according to the scheduling information in the SIB 1. In this embodiment, no valid duration is provided in the updated SIBX and the UE does not start the timer T3XX again.

In some embodiments of the present disclosure, the UE receive an indication showing that the uplink synchronization assistance information or system information dedicated for the NTN/HAPS is updated and acquires the updated uplink synchronization assistance information or system information dedicated for the NTN/HAPS.

In this embodiment, the uplink synchronization assistance information comprises one or more of the following parameters: Network controlled common TA, Drift rate of the common TA, Variation of the common TA drift rate, x-coordinate of serving Satellite position state vector in the ECEF, y-coordinate of serving Satellite position state vector in the ECEF, z-coordinate of serving Satellite position state vector in the ECEF, a x-coordinate of serving Satellite velocity state vector in the ECEF, a y-coordinate of serving Satellite velocity state vector in the ECEF, a z-coordinate of serving Satellite velocity state vector in the ECEF, Semi-major axis a of the serving satellite, Eccentricity of the serving satellite, Argument of periapsis o of the serving satellite, Longitude of ascending node Q of the serving satellite, Inclination i of the serving satellite, Mean anomaly M [rad] at epoch time of the serving satellite, A validity duration configured by the network for uplink synchronization assistance information, the epoch time for assistance information, Polarization information for Downlink transmission on service link, Polarization information for Uplink service link, a reference location of a serving cell, time information indicating when a cell is going to stop serving the area covered by the cell, an indication of terminal specific TA reporting.

In this embodiment, the indication showing that the uplink synchronization assistance information and/or the system information dedicated for the NTN/HAPS is updated may be a valid time duration for the uplink synchronization assistance information and/or the system information dedicated for the NTN/HAPS and such information would be considered as updated when the time duration passes.

As an alternative or in addition, the indication showing that the uplink synchronization assistance information and/or the system information dedicated for the NTN/HAPS is updated may be indicated by an update of a value tag configured for the SIB comprising the uplink synchronization assistance information and/or the system information dedicated for the NTN/HAPS. For example, the value tag may be configured/introduced in a SIB which comprises scheduling information of the SIB comprising the uplink synchronization assistance information and/or the system information dedicated for the NTN/HAPS.

As an alternative or in addition, the indication showing that the uplink synchronization assistance information and/or the system information dedicated for the NTN/HAPS is updated may comprise a single bit indication in Short Message or paging DCI. Such bit indication indicates a modification of the SIB comprising the uplink synchronization assistance information and/or the system information dedicated for the NTN/HAPS.

The UE may acquire the updated uplink synchronization assistance information and/or the system information dedicated for the NTN/HAPS via the BCCH (according to the scheduling information of the SIB comprising the updated the uplink synchronization assistance information and/or the system information dedicated for the NTN/HAPS) or the RRCReconfiguration message.

FIG. 12 relates to a schematic diagram of a wireless terminal 120 according to some embodiments of the present disclosure. The wireless terminal 120 may be a user equipment (UE), a mobile phone, a laptop, a tablet computer, an electronic book or a portable computer system and is not limited herein. The wireless terminal 120 may include a processor 1200 such as a microprocessor or Application Specific Integrated Circuit (ASIC), a storage unit 1210 and a communication unit 1220. The storage unit 1210 may be any data storage device that stores a program code 1212, which is accessed and executed by the processor 1200. Embodiments of the storage unit 1212 include but are not limited to a subscriber identity module (SIM), read-only memory (ROM), flash memory, random-access memory (RAM), hard-disk, and optical data storage device. The communication unit 1220 may a transceiver and is used to transmit and receive signals (e.g. messages or packets) according to processing results of the processor 1200. In some embodiments, the communication unit 1220 transmits and receives the signals via at least one antenna 1222 shown in FIG. 12.

In some embodiments, the storage unit 1210 and the program code 1212 may be omitted and the processor 1200 may include a storage unit with stored program code.

The processor 1200 may implement any one of the steps in exemplified embodiments on the wireless terminal 120, e.g., by executing the program code 1212.

The communication unit 1220 may be a transceiver. The communication unit 1220 may as an alternative or in addition be combining a transmitting unit and a receiving unit configured to transmit and to receive, respectively, signals to and from a wireless network node (e.g. a base station).

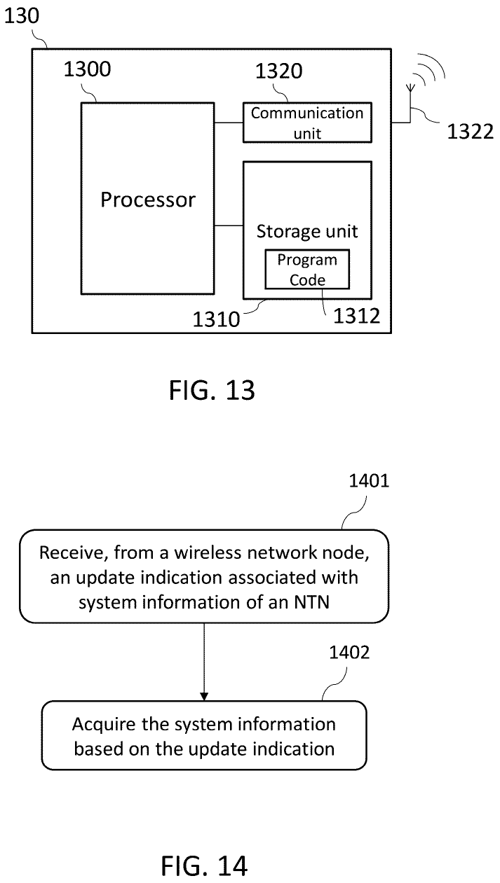

FIG. 13 relates to a schematic diagram of a wireless network node 130 according to some embodiments of the present disclosure. The wireless network node 130 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 130 may comprise (perform) at least one network function such as an access and mobility management function (AMF), a session management function (SMF), a user place function (UPF), a policy control function (PCF), an application function (AF), etc. The wireless network node 130 may include a processor 1300 such as a microprocessor or ASIC, a storage unit 1310 and a communication unit 1320. The storage unit 1310 may be any data storage device that stores a program code 1312, which is accessed and executed by the processor 1300. Examples of the storage unit 1312 include but are not limited to a SIM, ROM, flash memory, RAM, hard-disk, and optical data storage device. The communication unit 1320 may be a transceiver and is used to transmit and receive signals (e.g. messages or packets) according to processing results of the processor 1300. In an example, the communication unit 1320 transmits and receives the signals via at least one antenna 1322 shown in FIG. 13.

In some embodiments, the storage unit 1310 and the program code 1312 may be omitted. The processor 1300 may include a storage unit with stored program code.

The processor 1300 may implement any steps described in exemplified embodiments on the wireless network node 130, e.g., via executing the program code 1312.

The communication unit 1320 may be a transceiver. The communication unit 1320 may as an alternative or in addition be combining a transmitting unit and a receiving unit configured to transmit and to receive, respectively, signals to and from a wireless terminal (e.g. a user equipment or another wireless network node).

The present disclosure also proposes a communication system, which includes at least one wireless terminal and at least one wireless network node. The wireless terminal is any one mentioned above and performs any one of the wireless communication methods used in the wireless terminal of the present disclosure; and the wireless network node is any one mentioned above, and performs any wireless communication method for the wireless network node in the present disclosure. In some embodiments, the communication system is as shown in FIG. 1, the wireless network node is shown as NW, and the wireless terminal is shown as UE.

In embodiments of the communication system of the present disclosure, a wireless terminal receives an update indication associated with system information. Based on the update instruction, the wireless terminal acquires system information (e.g. acquires the SIB comprising the system information). As a result, the wireless terminal is allowed to timely acquire the updated system information and perform communications based on the updated system information. FIG. 14 shows a flowchart of a method according to some embodiments of the present disclosure. The method shown in FIG. 14 may be used in a wireless terminal (e.g. UE) and comprises the following steps:

Step 1401: Receive, from a wireless network node, an update indication associated with system information of an NTN.

Step 1402: Acquire the system information based on the update indication.

In the embodiment shown in FIG. 14, the wireless terminal receives an update indication associated with system information of an NTN (e.g. HAPS (system), HIBS (system)). Based on the update indication, the wireless terminal acquires the system information (e.g. acquires the SIB comprising the system information). As a result, the wireless terminal is allowed to timely acquire the updated system information and perform communications based on the updated system information.

In some embodiments, the system information comprises uplink synchronization assistance information and/or system information dedicated for the NTN (e.g. parameter(s) dedicated for the NTN/HAPS (system)).

In some embodiments, the system information comprises at least one of: a common TA, a drift rate of the common TA, a variation of the drift rate of the common TA, a x-coordinate of a serving node position state vector in an ECEF coordinate system, a y-coordinate of the serving node position state vector in the ECEF coordinate system, a z-coordinate of serving node position state vector in the ECEF coordinate system, a x-coordinate of serving node velocity state vector in the ECEF coordinate system, a y-coordinate of serving node velocity state vector in the ECEF coordinate system, a z-coordinate of serving node velocity state vector in the ECEF coordinate system, a semi-major axis of a serving node, an eccentricity of the serving node, an argument of periapsis of the serving node, a longitude of ascending node of the serving node, an inclination of the serving node, a mean anomaly at an epoch time of the serving node, a validity duration of the system information, an epoch time of the system information, polarization information for downlink transmissions on a service link, polarization information for an uplink service link, a reference location of a serving cell, time information indicating when a cell is going to stop serving the area covered by the cell or an indication of terminal specific TA reporting. Note that, the serving node of the NTN may be a satellite, an HAPS, an HIBS, a plane or a UAV.

In some embodiments, the update indication comprises/indicates a valid duration of the system information. In this embodiment, the wireless terminal acquires the system information when or after the valid duration passes. That is, the wireless terminal starts to acquire the system information when the valid duration passes. For example, the wireless terminal may start a timer when receiving the system information and the update indication, wherein a value of the timer is set to the valid duration. When the timer expires, the wireless terminal starts to acquire the system information.

In some embodiments, the update indication comprises a value tag. In this embodiment, the wireless terminal may receive an indication bit set to indicate a modification of a BCCH (e.g. systemInfoModification in Short Message set to 1). Based on the indication bit, the wireless terminal acquires the system information when the value tag is updated. For example, the value tag may be introduced in the existing SIB1 or a new SIB1 comprising scheduling information of SIB(s) comprising the system information. Note that, the value tag is configured/introduced for the SIB comprising the system information. In response to the indication bit, the wireless terminal acquires/receives the SIB1 comprising the value tag. If the value tag is updated, the wireless terminal acquires the SIB comprising (the SIB comprising) the system information based on the scheduling information comprised in the acquired/received SIB1.

In some embodiments, the maximum value of the value tag is greater than 31, so as to allow the system information to be updated as frequently as needed.

In some embodiments, the update indication comprises a newly introduced indication bit. The indication bit is introduced/used for indicating a modification of the system information (e.g. uplink synchronization assistance information or system information dedicated for the NTN). In this embodiment, when or after receiving the indication bit indicating the modification/update of the system information (e.g. the indication bit set to 1), the wireless terminal acquires or starts to acquire the system information.

In some embodiments, the indication bit is (comprised/introduced) in a short message (e.g. uplinkSyncAssistanceInfoIndication or ntnsystemInfoModification in Short Message) or paging DCI.

Note that, the update indication may comprise at least one of the valid duration, the value tag and/or the indication bit. For example, the wireless terminal may first receive a valid duration of the system information. During this valid duration, the wireless terminal may receive a short message comprising an indication bit indicating a modification/update of the system information. Under such conditions, the wireless terminal may start to acquire the system information immediately after receiving the short message. More examples can be found in FIGS. 7, 8, 10 and 11.

In some embodiments, the wireless terminal acquires the system information via the BCCH or an RRC message.

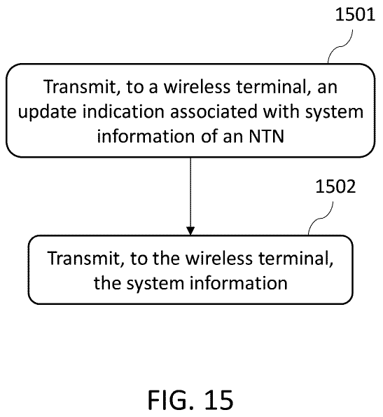

FIG. 15 shows a flowchart of a method according to some embodiments of the present disclosure.

The method shown in FIG. 15 may be used in a wireless network node (e.g. RAN node, relay) and comprises the following steps:

Step 1501: Transmit, to a wireless terminal, an update indication associated with system information of an NTN.

Step 1502: Transmit, to the wireless terminal, the system information.

In FIG. 15, the wireless network node transmits an update indication associated with system information of an NTN (e.g. HAPS (system), HIBS system) to a wireless terminal (e.g. UE), to indicate a modification/update of the system information and/or to indicate the wireless terminal to acquire the system information (e.g. to acquire the SIB comprising the system information). The wireless network node transmits the updated/modified system information to the wireless terminal, e.g., via a BCCH or an RRC message.

In some embodiments, the system information comprises uplink synchronization assistance information and/or system information dedicated for the NTN (e.g. parameter(s) dedicated for the NTN/HAPS (system)).

In some embodiments, the system information comprises at least one of: a common TA, a drift rate of the common TA, a variation of the drift rate of the common TA, a x-coordinate of a serving node position state vector in an ECEF coordinate system, a y-coordinate of the serving node position state vector in the ECEF coordinate system, a z-coordinate of serving node position state vector in the ECEF coordinate system, a x-coordinate of serving node velocity state vector in the ECEF coordinate system, a y-coordinate of serving node velocity state vector in the ECEF coordinate system, a z-coordinate of serving node velocity state vector in the ECEF coordinate system, a semi-major axis of a serving node, an eccentricity of the serving node, an argument of periapsis of the serving node, a longitude of ascending node of the serving node, an inclination of the serving node, a mean anomaly at an epoch time of the serving node, a validity duration of the system information, an epoch time of the system information, polarization information for downlink transmissions on a service link, or polarization information for an uplink service link, a reference location of a serving cell, time information indicating when a cell is going to stop serving the area covered by the cell or an indication of terminal specific TA reporting. Note that, the serving node of the NTN may be a satellite, an HAPS, an HIBS, a plane or a UAV.

In some embodiments, the update indication comprises/indicates a valid duration of the system information. In this embodiment, the wireless network node transmits the system information when or after the valid duration passes.

In some embodiments, the update indication comprises a value tag. For example, the value tag may be introduced in the existing SIB1 or a new SIB1 comprising scheduling information of SIB(s) comprising the system information. Note that, the value tag is configured/introduced for the SIB comprising the system information. In this embodiment, when the system information is (needed to be) modified/updated, the wireless network node transmits an indication bit indicating an modification in a BCCH (e.g. systemInfoModification in Short Message set to 1) to the wireless terminal and updates/changes the value tag. In response to the indication bit, the wireless terminal acquires the SIB1 comprising the updated value tag. Because of the update of the value tag, the wireless terminal (starts to) acquires the SIB comprising the system information based on scheduling information of the acquired SIB1.

In some embodiments, the maximum value of the value tag is greater than 31, so as to allow the system information to be updated as frequently as needed.

In some embodiments, the update indication comprises a newly introduced indication bit. The indication bit is introduced/used for indicating a modification of the system information (e.g. uplink synchronization assistance information or system information dedicated for the NTN). In this embodiment, when or after the system information is modified or updated, the wireless network node transmits the indication bit indicating the modification/update of the system information (e.g. the indication bit set to 1) to the wireless terminal. Based on the indication bit, the wireless terminal starts to acquire the system information.

In some embodiments, the indication bit is (comprised/introduced) in a short message (e.g. uplinkSyncAssistanceInfoIndication or ntnsystemInfoModification in Short Message) or paging DCI.

Note that, the update indication may comprise at least one of the valid duration, the value tag and/or the indication bit (see embodiments shown in FIGS. 2 to 11).

While various embodiments of the present disclosure have been described above, it should be understood that they have been presented by way of example only, and not by way of limitation.

Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

We claim:

1. A wireless communication method for use in a wireless terminal, the method comprising:
receiving, from a wireless network node, an update indication associated with system information of a non-terrestrial network, and
acquiring the system information based on the update indication.

2. The wireless communication method of claim 1, wherein the system information comprises at least one of:
a common timing advance (TA),
a drift rate of the common TA,
a variation of the drift rate of the common TA,
a x-coordinate of a serving node position state vector in an Earth-centered Earth-fixed(ECEF), coordinate system,
a y-coordinate of the serving node position state vector in the ECEF coordinate system,
a z-coordinate of serving node position state vector in the ECEF coordinate system,
a x-coordinate of serving node velocity state vector in the ECEF coordinate system,
a y-coordinate of serving node velocity state vector in the ECEF coordinate system,
a z-coordinate of serving node velocity state vector in the ECEF coordinate system,
a semi-major axis of a serving node,
an eccentricity of the serving node,
an argument of periapsis of the serving node,
a longitude of ascending node of the serving node,
an inclination of the serving node,
a mean anomaly at an epoch time of the serving node,
a validity duration of the system information,
an epoch time of the system information,
polarization information for downlink transmissions on a service link,
polarization information for an uplink service link,
a reference location of a serving cell,
time information indicating when a cell is going to stop serving the area covered by the cell, or
an indication of terminal specific TA reporting.

3. The wireless communication method of claim 1, wherein,
acquiring the system information based on the update indication comprises: acquiring the system information when a valid duration indicated by the update indication passes; or
the system information is transmitted via a broadcast channel or a radio resource control message; or
the system information comprises at least one of uplink synchronization assistance information or system information dedicated for the non-terrestrial network.

4. The wireless communication method of claim 1, further comprising:
receiving, from the wireless network node, an indication bit set to indicate a modification of a broadcast channel,
wherein acquiring the system information based on the update indication comprises:
acquiring the system information when a value tag comprised in the update indication is updated.

5. The wireless communication method of claim 4, wherein a maximum value of the value tag is greater than 31.

6. The wireless communication method of claim 4, wherein the value tag is configured for a system information block comprising the system information.

7. The wireless communication method of claim 1, wherein acquiring the system information based on the update indication comprises:
acquiring the system information when an indication bit comprised in the update indication indicates that the system information is updated.

8. The wireless communication method of claim 7, wherein the indication bit is in a short message or paging downlink control information.

9. A wireless communication method for use in a wireless network node, the method comprising:
transmitting, to a wireless terminal, an update indication associated with system information of a non-terrestrial network, and
transmitting, to the wireless terminal, the system information.

10. The wireless communication method of claim 9, wherein the system information comprises at least one of:
a common timing advance (TA),
a drift rate of the common TA,
a variation of the drift rate of the common TA,
a x-coordinate of a serving node position state vector in an Earth-centered Earth-fixed (ECEF), coordinate system,
a y-coordinate of the serving node position state vector in the ECEF coordinate system,
a z-coordinate of serving node position state vector in the ECEF coordinate system,
a x-coordinate of serving node velocity state vector in the ECEF coordinate system,
a y-coordinate of serving node velocity state vector in the ECEF coordinate system,
a z-coordinate of serving node velocity state vector in the ECEF coordinate system,
a semi-major axis of a serving node,
an eccentricity of the serving node,
an argument of periapsis of the serving node,
a longitude of ascending node of the serving node,
an inclination of the serving node,
a mean anomaly at an epoch time of the serving node,
a validity duration of the system information,
an epoch time of the system information,
polarization information for downlink transmissions on a service link, or
polarization information for an uplink service link,
a reference location of a serving cell,
time information indicating when a cell is going to stop serving the area covered by the cell, or
an indication of terminal specific TA reporting.

11. The wireless communication method of claim 9, wherein,
the update indication comprises a valid duration of the system information; or
the system information is transmitted via a broadcast channel or a radio resource control message; or
the system information comprises at least one of uplink synchronization assistance information or system information dedicated for the non-terrestrial network; or
the update indication comprises an indication bit set to indicate that the system information is updated.

12. The wireless communication method of claim 9, wherein the update indication comprises a value tag which is updated; and
wherein the method further comprises:
transmitting, to the wireless terminal, an indication bit set to indicate a modification of a broadcast channel.

13. The wireless communication method of claim 12, wherein a maximum value of the value tag is greater than 31.

14. The wireless communication method of claim 12, wherein the value tag is configured for a system information block comprising the system information.

15. The wireless communication method of claim 9, wherein the update indication comprises an indication bit set to indicate that the system information is updated, and the indication bit is in a short message or paging downlink control information.

16. A wireless terminal, comprising:
a memory; and
a processor coupled to the memory, wherein the processor is configured to perform the copy area identification method according to claim 1.

17. A wireless network node, comprising:
a memory; and
a processor coupled to the memory, wherein the processor is configured to perform the copy area identification method according to claim 9.

18. A non-transitory computer-readable storage medium having stored thereon computer program instructions, wherein the instructions, when executed by a processor, implement the steps of the copy area identification method according to claim 1.

19. A non-transitory computer-readable storage medium having stored thereon computer program instructions, wherein the instructions, when executed by a processor, implement the steps of the copy area identification method according to claim 9.

20. A wireless communication system, comprising:
a wireless terminal configured to receive, from a wireless network node, an update indication associated with system information of a non-terrestrial network, and acquire the system information based on the update indication; and
a wireless network node configured to transmit, to a wireless terminal, an update indication associated with system information of a non-terrestrial network, and transmit, to the wireless terminal, the system information.
